(19) United States
(12) Patent Application Publication
(10) Pub. No.: US 2003/0104164 A1
(43) Pub. Date: Jun. 5, 2003

(54) Shock-absorbing sole pad

(76) Inventor: Pony Wu, Taichung Hsien (TW)

Correspondence Address: LADAS & PARRY, 224 SOUTH MICHIGAN AVENUE, SUITE 1200, CHICAGO, IL, 60604, US

(21) Appl. No.: 10/004,596

(22) Filed: Dec. 5, 2001

(51) Int. Cl. B32B 3/00

(52) U.S. Cl. 428/102; 428/156; 428/138

(57) ABSTRACT

A shock-absorbing sole pad includes a pad body, a plurality of spring members, and an air permeable covering. The pad body has a lower pad surface formed with spring receiving recesses. The spring members are disposed respectively in the spring receiving recesses, and have upper ends connected to the pad body and lower ends disposed outwardly and respectively of the spring receiving recesses. The air permeable covering has upper and lower covering portions that cover respectively the upper and lower pad surfaces of the pad body such that the lower ends of the spring members abut against the lower covering portion.

### BACKGROUND OF THE INVENTION

1. Field of the Invention

The invention relates to a sole pad, more particularly to a shock-absorbing sole pad.

2. Description of the Related Art

Referring to FIG. 1, a conventional sole pad comprises a pad body 10 and an air permeable lining 20. The pad body 10 has an upper pad surface 11 and a lower pad surface 13 formed with a plurality of hollow protruding posts 12. The air permeable lining 20 has a lower lining surface 21 that covers the upper pad surface 11 of the pad body 10, an upper lining surface 22 opposite to the lower lining surface 21, and a plurality of vent holes 23, each of which extends from the upper lining surface 22 to the lower lining surface 21, and is registered with a respective one of the protruding posts 12.

In use, the pad body 10 and the air permeable lining 20 are disposed in a shoe body 30. When the wearer's foot (not shown) applies pressure on the sole pad, the protruding posts 12 are deformed, and air is released via the vent holes 23 and flows around the wearer's foot. However, in actual use, since the protruding posts 12 of the pad body 10 are mainly formed by injecting plastic materials, manufacturing process is rather complicated as air permeability and the locations of the vent holes 23 have to be considered. Furthermore, even though the protruding posts are resilient, the extent of compression is limited by material factors, which in turn, affects air flow.

### SUMMARY OF THE INVENTION

Therefore, the main object of the present invention is to provide a shock-absorbing sole pad that is capable of overcoming the aforementioned drawbacks of the prior art.

Accordingly, a shock-absorbing sole pad of the present invention comprises a pad body, a plurality of spring members, and an air permeable covering. The pad body has an upper pad surface and a lower pad surface that is formed with a plurality of spring receiving recesses. Each of the spring members is disposed in a respective one of the spring receiving recesses, and has upper and lower ends. The upper end is connected to the pad body. The lower end is disposed outwardly of the respective one of the spring receiving recesses. The air permeable covering has upper and lower covering portions. The upper covering portion covers the upper pad surface. The lower covering portion covers the lower pad surface such that the lower ends of the spring members abut against the lower covering portion.

### BRIEF DESCRIPTION OF THE DRAWINGS

Other features and advantages of the present invention will become apparent in the following detailed description of the preferred embodiment with reference to the accompanying drawings, of which:

FIG. 1 is a cross-sectional view illustrating a shoe body that incorporates a conventional sole pad;

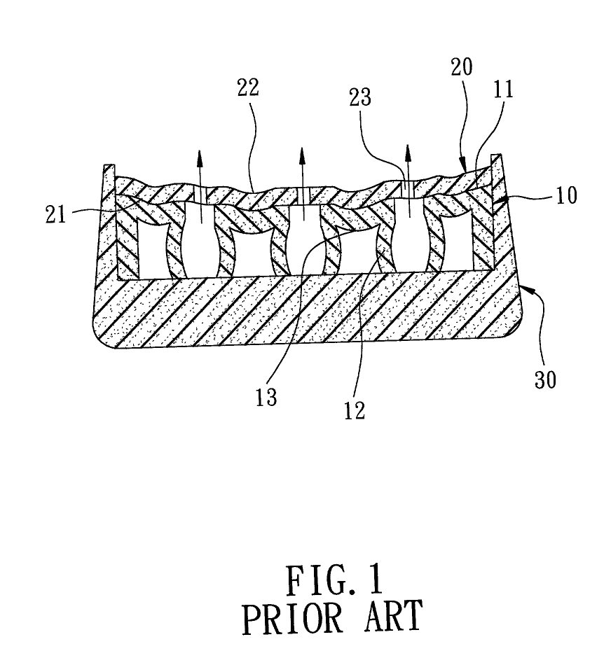

FIG. 2 is an inverted exploded perspective view showing a pad body and spring members of the preferred embodiment of a shock-absorbing sole pad according to the present invention;

FIG. 3 is an inverted assembled perspective view of the preferred embodiment;

FIG. 4 is a cross-sectional view illustrating a shoe body that incorporates the preferred embodiment;

FIG. 5 is cross-sectional view of the preferred embodiment in a compressed state.

### DETAILED DESCRIPTION OF THE PREFERRED EMBODIMENT

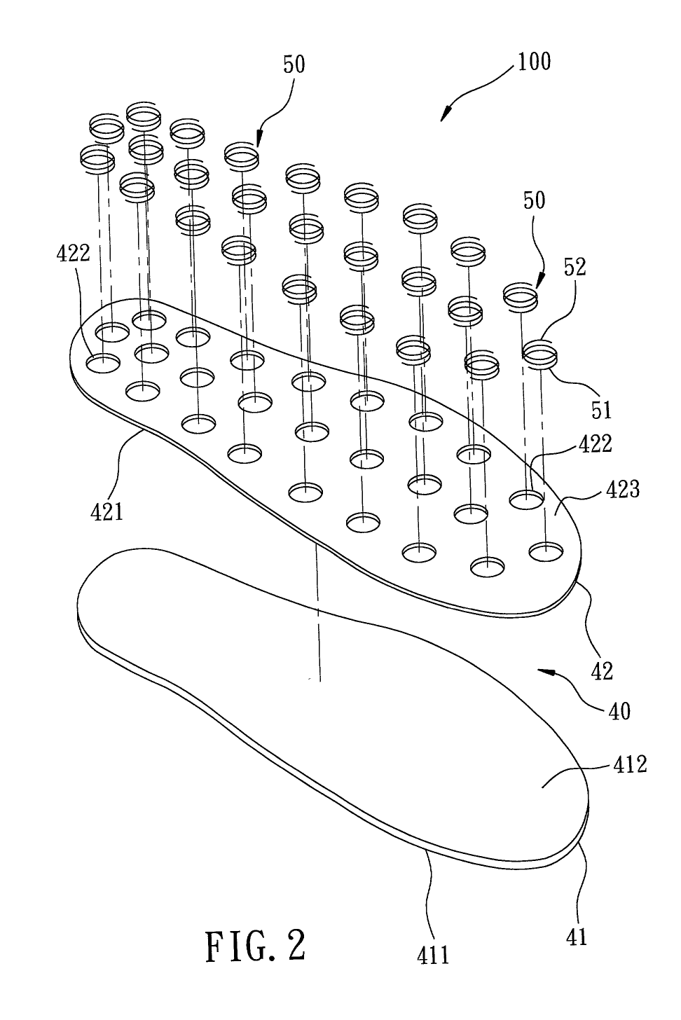

Referring to FIGS. 2 to 5, the preferred embodiment of a shock-absorbing sole pad 100 according to the present invention is shown to comprise a pad body 40, a plurality of spring members 50, and an air permeable covering 60. The pad body 40 is formed from an air permeable foam material, and includes superimposed upper and lower pad layers 41, 42. The upper pad layer 41 has an upper surface 411 that serves as an upper pad surface, and a lower surface 412 opposite to the upper surface 411. The lower pad layer 42 has an upper surface 421 that is adhered to the lower surface 412 of the upper pad layer 41, and a lower surface 423 that is opposite to the upper surface 421 of the lower pad layer 42 and that serves as a lower pad surface. The lower pad layer 42 is formed with a plurality of openings that extend through the upper and lower surfaces 421, 423 of the lower pad layer 42 and that cooperate with the lower surface 412 of the upper pad layer 41 so as to form a plurality of spring receiving recesses 422.

Each of the spring members 50 is formed as a coiled compression spring, is disposed in a respective one of the spring receiving recesses 422, and has upper and lower ends 51, 52, as best shown in FIG. 2. The upper end 51 is bonded to the pad body 40. The lower end 52 is disposed outwardly of the respective one of the spring receiving recesses 422.

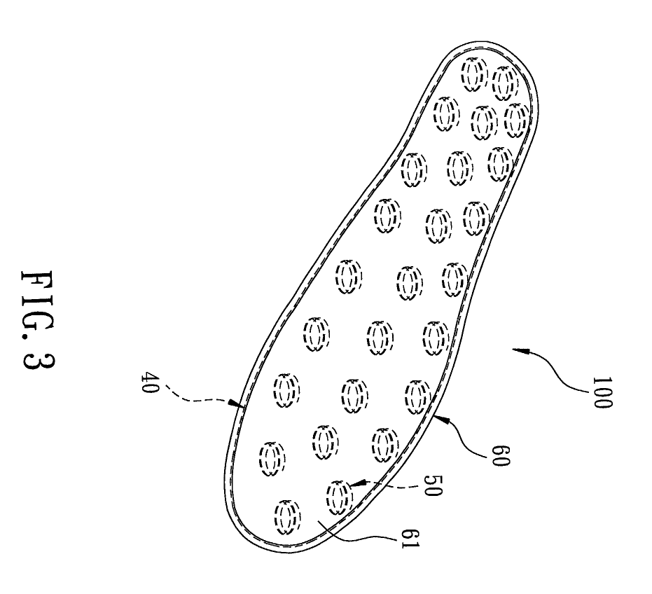

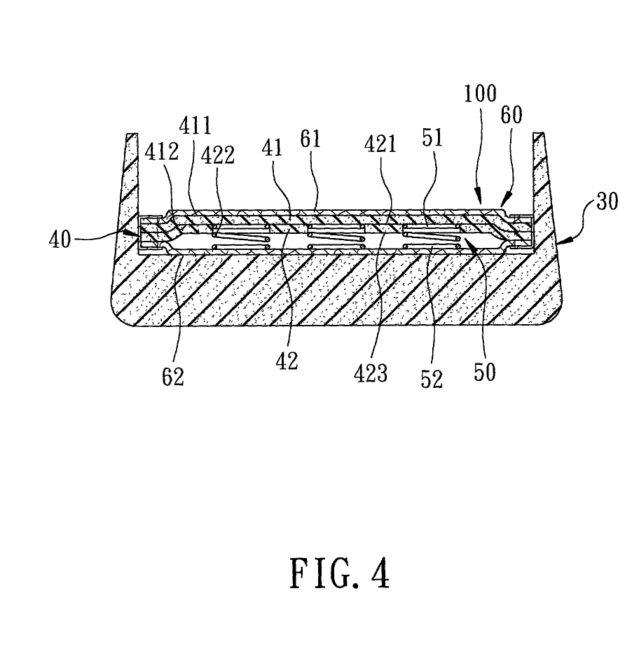

The air permeable covering 60 is formed from an air permeable woven fabric, and has upper and lower covering portions 61, 62. The upper covering portion 61 covers the upper surface 411 of the upper pad layer 41, whereas the lower covering portion 62 covers the lower surface 423 of the lower pad layer 42. The upper and lower covering portions 61, 62 of the air permeable covering 60 and the upper and lower pad layers 41, 42 of the pad body 40 have peripheral parts that are sewn together so that the lower ends 52 of the spring members 50 can be maintained to abut against the lower covering portion 62, as best illustrated in FIGS. 3 and 4.

During assembly, after the upper and lower pad layers 41, 42 of the pad body 40 are integrally adhered together by the use of adhesives, the spring members 50 are then secured in the spring receiving recesses 422 in the lower pad layer 42 of the pad body 40. Finally, the air permeable covering 60 and the pad body 40 are sewn together.

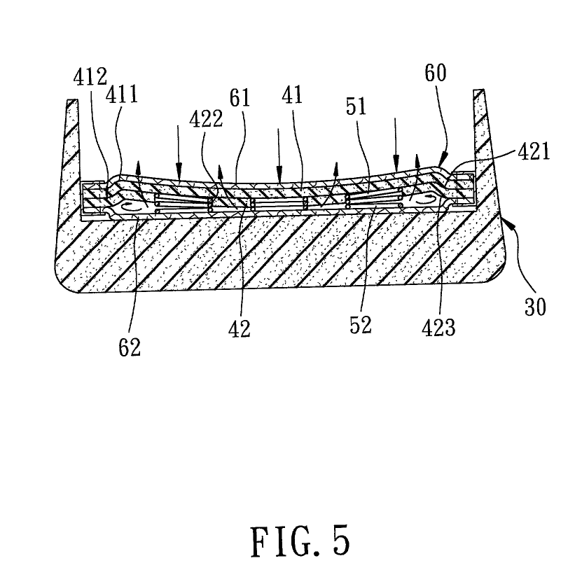

In use, the sole pad 100 is disposed in a shoe body 30 (see FIGS. 4 and 5). When the wearer's foot (not shown) applies pressure on the sole pad 100, the spring members 50 are compressed by the pad body 40, and air in the recesses 422 is released through the pad body 40 and the air permeable covering 60 and flows around the wearer's foot. When the wearer's foot is lifted from the ground, the spring members 50 are restored to their normal states since no load is applied on the pad body 40. Air enters into the spring receiving recesses 422 at this time.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A shock-absorbing sole pad comprising:
a pad body having an upper pad surface and a lower pad surface that is formed with a plurality of spring receiving recesses;
a plurality of spring members, each of which is disposed in a respective one of said spring receiving recesses, and has an upper end connected to said pad body and a lower end disposed outwardly of the respective one of said spring receiving recesses; and
an air permeable covering having an upper covering portion that covers said upper pad surface, and a lower covering portion that covers said lower pad surface such that said lower ends of said spring members abut against said lower covering portion.

2. The shock-absorbing sole pad as claimed in claim 1, wherein said pad body includes superimposed upper and lower pad layers,
said upper pad layer having an upper surface that serves as said upper pad surface, and a lower surface opposite to said upper surface,
said lower pad layer having an upper surface that is adhered to said lower surface of said upper pad layer, and a lower surface that is opposite to said upper surface of said lower pad layer and that serves as said lower pad surface, said lower pad layer being formed with a plurality of openings that extend through said upper and lower surfaces of said lower pad layer and that cooperate with said lower surface of said upper pad layer so as to form said spring receiving recesses.

3. The shock-absorbing sole pad as claimed in claim 2, wherein said upper and lower covering portions and said upper and lower pad layers have peripheral parts that are sewn together.

4. The shock-absorbing sole pad as claimed in claim 1, wherein each of said spring members is formed as a coiled compression spring.

5. The shock-absorbing sole pad as claimed in claim 1, wherein said air permeable covering is formed from an air permeable woven fabric.

6. The shock-absorbing sole pad as claimed in claim 1, wherein said pad body is formed from an air permeable foam material.
